(19) United States
(12) Patent Application Publication
(10) Pub. No.: US 2008/0218833 A1
(43) Pub. Date: Sep. 11, 2008

(54) Laser repair system

(76) Inventors: Dong Il Son, Cheonan (KR); Duk Sung Kim, Yeosu (KR); Sung Haeng Cho, Cheongwon (KR); Won Hee Song, Uijeongbu (KR); Chang Hyuk Jeong, Bucheon (KR)

Correspondence Address: MACPHERSON KWOK CHEN & HEID LLP, 2033 GATEWAY PLACE, SUITE 400, SAN JOSE, CA, 95110, US

(21) Appl. No.: 12/072,091

(22) Filed: Feb. 22, 2008

(30) Foreign Application Priority Data
Feb. 22, 2007 (KR) 10-2007-0017861

(51) Int. Cl. G02B 26/02

(52) U.S. Cl. 359/232

(57) ABSTRACT

A laser repair system including a laser light oscillator for generating laser light, and a slit unit on which the laser light is irradiated and which includes a laser light-blocking section, a first slit section and a second slit section, wherein the laser light-blocking section of the slit unit does not transmit the laser light incident on the laser light-blocking section, and the amount of light transmitted through the first slit section is greater than that of light transmitted through the second slit section.

This application claims priority to Korean Patent application No. 10-2007-0017861, filed on Feb. 22, 2007 and all the benefits accruing therefrom under 35 U.S.C. 119, the contents of which are herein incorporated by reference in its entirety.

### BACKGROUND OF THE INVENTION

1. Field of the Invention

The present invention relates to a laser repair system.

2. Description of the Related Art

A repairing process for line and pixel defects that may be generated in manufacturing a flat display panel is currently performed by cutting a corresponding layer or welding upper and lower layers using laser light.

In general, a laser repair system employs slits to define a processing area. The width of laser light generated by a laser light oscillator is properly blocked in partial for minute processing by using slits so as to adjust the laser light to a desired shape and size of the laser light for a laser repair process.

In the laser repair process, a cutting process hardly fails when laser light having power more than a threshold is used.

However, in a welding process, i.e., a process of electrically connecting upper and lower wirings through welding, the welding is not performed if laser light power is too low. If the laser light power is too high, metal wiring is excessively melted and vaporized so that it is not possible to create an electrical short circuit path between layers. If a conductive layer and an insulating layer (including a passivation layer) are not completely removed in the welding process, residues including a conductive metal may cause an additional defect when a product is moved to other places after shipment, or cause a phenomenon in which the residues are electrically connected to an upper electrode of a flat display panel when the panel is pressed, resulting in the reoccurrence of a defect in a repaired portion.

A conventional welding process is repeatedly performed two or more times with laser light of suitable power mainly using square slits, thereby minimizing a failure rate of the welding process.

Since the same process is repeatedly performed, process time increases. Furthermore, as the thickness of wiring and electromigration resistance are reduced upon use of low-resistance wiring, such as pure aluminum (Al), for a recent large-sized high-resolution panel, it is difficult to secure a margin for the laser repair process.

### SUMMARY OF THE INVENTION

Accordingly, the present invention is to provide a laser repair system including a slit unit capable of adjusting a power profile of laser light.

According to an aspect of the present invention, there is provided a laser repair system including a laser light oscillator for generating laser light, and a slit unit on which the laser light is irradiated and which includes a laser light-blocking section, a first slit section and a second slit section, wherein the laser light-blocking section of the slit unit does not transmit the laser light incident thereon, and the amount of light transmitted through the first slit section is greater than that transmitted through the second slit section.

The second slit section may be formed around the first slit section.

The laser light-blocking section may include a first laser light-blocking section having a first opening, and a second laser light-blocking section having a second opening. The first and the second laser light-blocking sections may be disposed to intersect each other, and the first slit section may include an overlapping region of the first and the second openings.

The first laser light-blocking section may include a first plate and a second plate spaced apart from the first plate, and the second laser light-blocking section may include a third plate and a fourth plate spaced apart from the third plate.

The slit unit may further include a driving section for changing positions of the first and the second laser light-blocking sections.

The driving section may include a first driving section connected to the first laser light-blocking section to move the first and the second plates along a first direction; and a second driving section connected to the second laser light-blocking section to move the third and the fourth plates along a second direction.

The second slit section may include a slit formed in at least one of the first laser light-blocking section and the second laser light-blocking section.

The slit may be formed as a rectangular hole.

The plate may be formed with a slit including a plurality of rectangular holes spaced apart each other.

The rectangular holes may have different sizes.

The plate may be formed with a slit including a plurality of holes spaced apart each other.

The second slit section may include uneven edges formed in at least one end of the first and the second laser light-blocking sections.

The uneven edges may be formed in a polygonal or round shape.

The second slit section may include a semi-transmissive portion made of a semi-transmissive material capable of transmitting a part of laser light incident on the second slit section, and the semi-transmissive portion may be formed in at least one end of the first and the second laser light-blocking sections.

The semi-transmissive material may include semi-transmissive glass or semi-transmissive metal.

According to another aspect of the present invention, there is provided a laser repair system including a laser light oscillator for generating laser light, and a slit unit on which the laser light is irradiated. The slit unit includes a laser light-blocking section and a first slit section. T he laser light-blocking section of the slit unit does not transmit laser light incident thereon, and the first slit section transmits laser light incident thereon and filters the laser light such that a power distribution of the transmitted laser light varies.

The first slit section may be formed in a polygonal shape so that the width of one side is different from that of the opposite side.

The laser light-blocking section may include a first laser light-blocking section having a first opening, and a second laser light-blocking section having a second opening. The first and the second laser light-blocking sections may be disposed to intersect each other. The first slit section may include an overlapping region of the first and the second opening, and at least one of the first and the second openings may have a gradually reduced width.

The first laser light-blocking section may include a first plate and a second plate spaced apart from the first plate, the second laser light-blocking section may include a third plate and a fourth plate spaced apart from the third plate. The first and the second plate may be disposed to be inclined with respect to each other in an identical plane.

The third and the fourth plate may be disposed to be inclined with respect to each other in an identical plane.

The slit unit may further include the second slit section. The second slit section may be formed in the laser light-blocking section, and the amount of light transmitted through the second slit section may be less than that transmitted through the first slit section.

The slit unit may further include a driving section for changing positions of the first and the second laser light-blocking sections.

A central portion of the first slit section may be disposed in a peripheral region of the laser light.

The first slit section may include a rectangular slit having a length ratio of a first to a second side of 1:100˜1:1000.

### BRIEF DESCRIPTION OF THE DRAWINGS

Preferred embodiments of the present invention can be understood in more detail from the following description taken in conjunction with the accompanying drawings, in which:

FIG. 1 is a schematic diagram of a laser repair system according to the present invention;

FIG. 2 is a perspective view of a slit unit of a laser repair system according to a first embodiment of the present invention;

FIG. 3A is a perspective view of the assembled slit unit shown in FIG. 2.

FIGS. 3B to 3D are plan views of the slit unit shown in FIG. 2.

FIGS. 4A, 4B and 5 are plan views of a slit unit according to an exemplary modification of the first embodiment of the present invention;

FIG. 6A is a plan view illustrating a light exposure region of the slit unit shown in FIG. 2;

FIG. 6B shows a curve which illustrates a power distribution of laser light transmitted through the slit unit;

FIGS. 7 and 8 are perspective and plan views respectively illustrating a slit unit according to a second embodiment of the present invention;

FIGS. 9A to 9C are plan views of a slit unit according to a third embodiment of the present invention;

FIGS. 10A and 10B are sectional views of a liquid crystal display panel that is subjected to a repair process using a laser repair system according to an embodiment of the present invention;

FIG. 11 illustrates images showing laser repair results depending on the size of a slit with constant power of laser light;

FIG. 12 illustrates images showing laser repair results depending on the power of laser light with constant slit size;

FIGS. 13A and 13B are perspective and plan views of a slit unit according to a fourth embodiment of the present invention, respectively;

FIG. 14 shows a curve which illustrates a power distribution of laser light transmitted through the slit unit according to the fourth embodiment of the present invention;

FIG. 15A is a view of a slit unit according to a fifth embodiment of the present invention;

FIG. 15B shows a curve which illustrates a power distribution of laser light transmitted through the slit unit according to the fifth embodiment of the present invention;

FIG. 16A is a plan view of a slit unit according to a sixth embodiment of the present invention; and

FIG. 16B shows a curve which illustrates a power distribution of laser light transmitted through the slit unit according to the sixth embodiment of the present invention.

### DETAILED DESCRIPTION OF THE PREFERRED EMBODIMENT

Hereinafter, preferred embodiments of the present invention are described in detail with reference to the accompanying drawings.

However, the present invention is not limited to the embodiments disclosed below but may be implemented into different forms. These embodiments are provided only for illustrative purposes and for full understanding of the scope of the present invention by those skilled in the art. Throughout the drawings, like reference numerals are used to designate like elements.

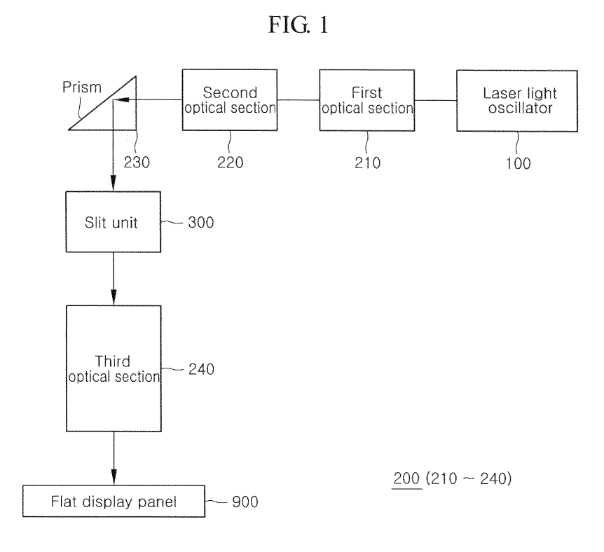

FIG. 1 is a block diagram of a laser repair system according to the present invention.

Referring to FIG. 1, the laser repair system includes a laser light oscillator 100, an optical unit 200, and a slit unit 300. The optical unit 200 includes a first optical section 210, a second optical section 220, a prism 230, and a third optical section 240.

The laser light oscillator 100 generates and outputs laser light. The first optical section 210 is disposed in front of the laser light oscillator 100 to adjust the intensity of the laser light output from the laser light oscillator 100. For example, the first optical section 210 may include an attenuator for attenuating the intensity of the laser light.

The second optical section 220 is disposed in front of the first optical section 210 to change characteristics of the laser light output from the first optical section 210. For example, the second optical section 220 may include a condensing lens for improving uniformity of the laser light.

The prism 230 is disposed in front of the second optical section 220 to reflect the laser light output from the second optical section 220. Although the prism is used in this embodiment, a reflective mirror may be used.

The slit unit 300 is disposed in front of the prism 230 to transmit at least a part of the laser light reflected by the prism 230. The slit unit 300 blocks a part of incident laser light and transmits the other part therethrough so as to adjust the laser light to a desired shape and size. The slit unit 300 also adjusts the amount of the transmitted laser light and then a power distribution of the laser light. The slit unit 300 will be described in detail below.

The third optical section 240 is disposed in front of the slit unit 300 to perform reduced or enlarged projection of the laser light transmitted through the slit unit 300 to an object to be repaired 900, e.g., a flat display panel.

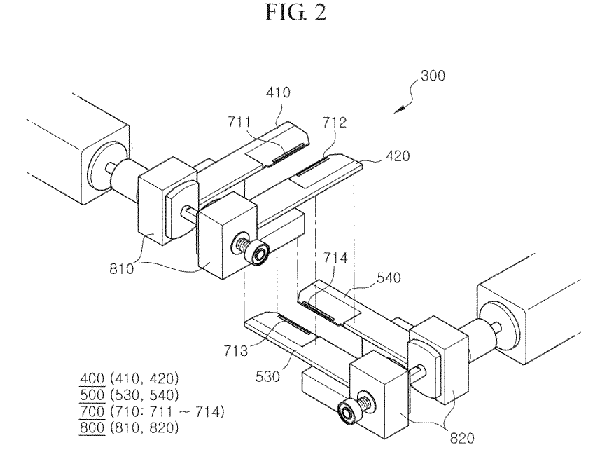

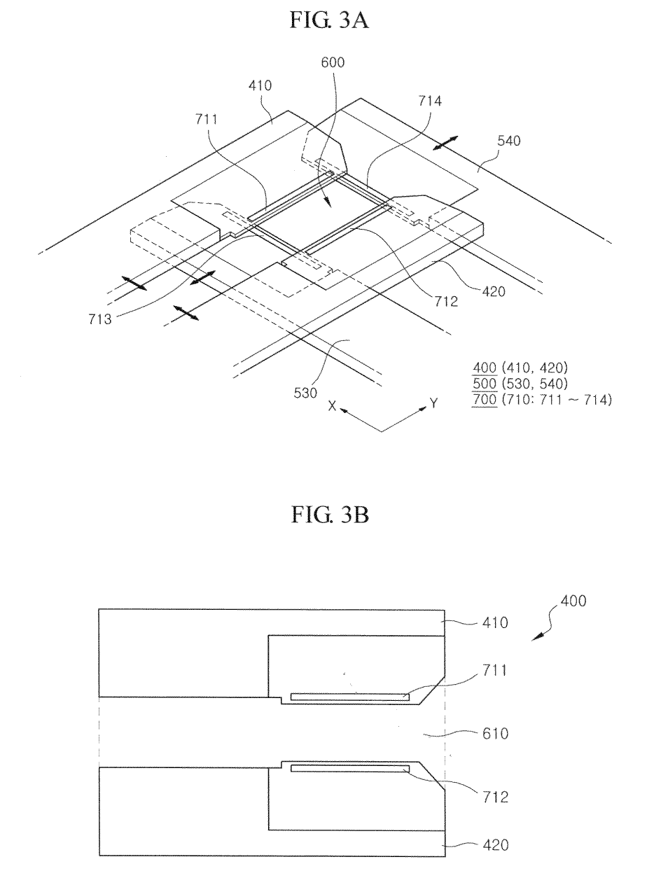

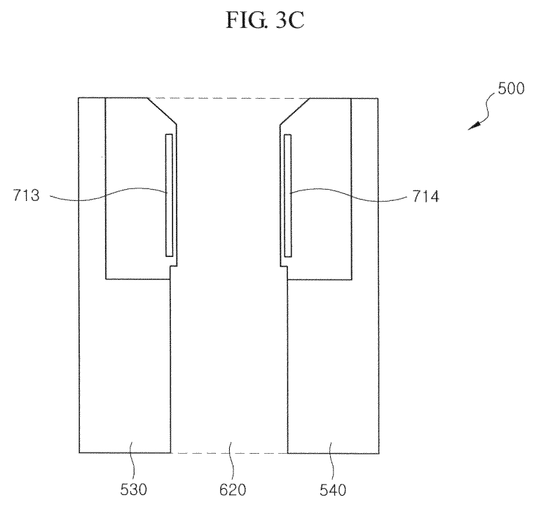

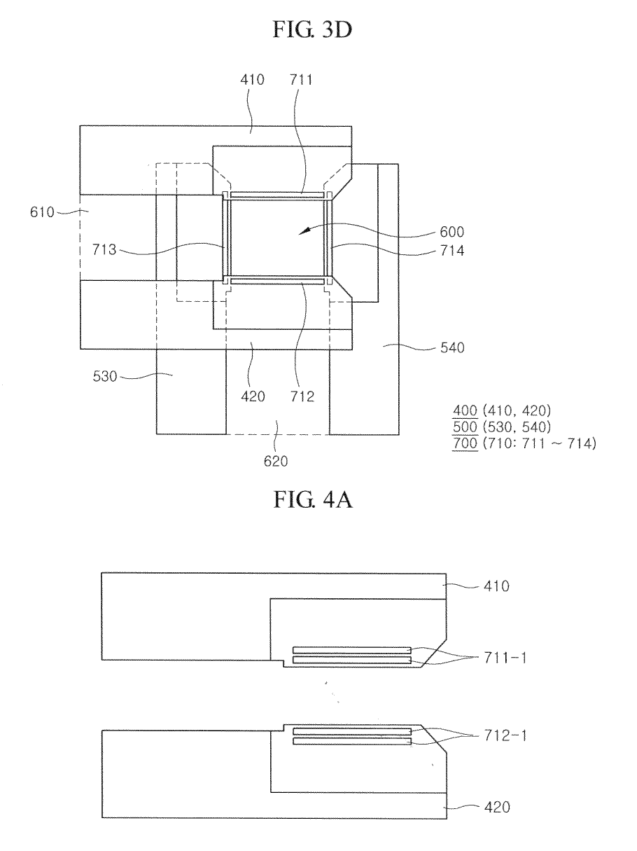

FIG. 2 is a perspective view of a slit unit of a laser repair system according to a first embodiment of the present invention. FIG. 3A is a perspective of a part of the slit unit shown in FIG. 2 assembled together. FIGS. 3B to 3D are plan views of the slit unit shown in FIG. 2.

Referring to FIGS. 2 to 3D, the slit unit 300 includes a first laser light-blocking section 400, a second laser light-blocking section 500, a first slit section 600, a second slit section 700, and a driving section 800. The driving section 800 includes a first driving section 810 and a second driving section 820.

The first laser light-blocking section 400 and the second laser light-blocking section 500 of the slit unit 300 block all of laser light incident thereon. The first laser light-blocking section 400 and the second laser light-blocking section 500 are made of laser light-blocking material. Although the laser light-blocking sections are made of metal in this embodiment, they are not limited thereto but may be made of various materials.

The first slit section 600 is formed by the first laser light-blocking section 400 and the second laser light-blocking section 500. The first slit section 600 defines the shape and size of the laser light and transmits all of laser light incident thereon.

The second slit section 700 is formed by making slits in the first laser light-blocking section 400 and the second laser light-blocking section 500, and transmits a part of laser light incident thereon. As a result, the power of the laser light transmitted through the first slit section 600 is different from that transmitted through the second slit section 700. That is, the power of the laser light transmitted through the first slit section 600 is relatively greater than that transmitted through the second slit section 700. Accordingly, the laser light transmitted through the slit unit 300 has a varied power distribution.

Further, the driving section 800 includes a first driving section 810 and a second driving section 820. The first driving section 810 drives the first laser light-blocking section 400 and the second driving section 820 drives the second laser light-blocking section 500. The size and shape of the first slit section 600 are adjusted by controlling the first laser light-blocking section 400 and the second laser light-blocking section 500 using the first driving section 810 and the second driving section 820.

The structure of the slit unit 300 is described below in greater detail. The first laser light-blocking section 400 is connected to one end of the first driving section 810 and the second laser light-blocking section 500 is connected to one end of the second driving section 820. The first laser light-blocking section 400 and the second laser light-blocking section 500 are disposed to intersect each other. The first driving section 810 moves the first laser light-blocking section 400 along a first direction, e.g., an x-axis direction, and the second driving section 820 moves the second laser light-blocking section 500 along a second direction, e.g., an y-axis direction.

The first laser light-blocking section 400 includes a first plate 410 and a second plate 420. The first plate 410 has one end connected to the first driving section 810, and the second plate 420 has one end connected to the first driving section 810. The first driving section 810 may include two motors to drive separately the first plate 410 and the second plate 420. The first plate 410 and the second plate 420 are spaced apart from each other to define a first opening 610 (see FIG. 3B).

The first and the second laser light-blocking sections 400 and 500 are spaced vertically apart intersecting each other. The second laser light-blocking section 500 includes a third plate 530 and a fourth plate 540. The third plate 530 has one end connected to the second driving section 820, and the fourth plate 540 has one end connected to the second driving section 820. The second driving section 820 may include two motors to drive separately the third plate 530 and the fourth plate 540. The third plate 530 and the fourth plate 540 are spaced apart from each other to define a second opening 620 (see FIG. 3C).

The first slit section 600 is formed by an overlapping area of the first opening 610 defined by the first laser light-blocking section 400 and the second opening 620 defined by the second laser light-blocking section 500 (see FIG. 3D). Since the first slit section 600, which is defined by the first opening 610 and the second opening 620, has no portion for blocking laser light, it transmits all the laser light therethrough.

Although the first slit section 600 is formed in a square or rectangular shape in this embodiment, the size and shape of the first slit section 600 may be changed using the first driving section 810 and the second driving section 820. Specifically, the first driving section 810 moves the first plate 410 and the second plate 420 laterally in the x-axis direction so as to adjust spacing between the first plate 410 and the second plate 420, i.e., the width of the first opening 610. The second driving section 820 moves the third plate 530 and the fourth plate 540 laterally in the y-axis direction so as to adjust spacing between the third plate 530 and the fourth plate 540, i.e., the width of the second opening 620. The size and shape of the first slit section 600 are adjusted by adjusting the widths of the first opening 610 and the second opening 620.

The second slit section 700 includes slits 710 formed in the first laser light-blocking section 400 and the second laser light-blocking section 500. The second slit section 700 transmits only a part of the laser light through the slits 710.

The slits 710 of the second slit section 700 include a first slit 711 formed in the first plate 410, a second slit 712 formed in the second plate 420, a third slit 713 formed in the third plate 530, and a fourth slit 714 formed in the fourth plate 540. Although the slits are formed in the first to the fourth plates 410, 420, 530 and 540, respectively, in this embodiment, this is only for illustrative purpose and the slits may be formed in fewer than all of the plates (e.g., one to three of the plates), if necessary.

Further, although the first to the fourth slits 711 to 714 are formed as rectangular holes in this embodiment, they are not limited thereto, and may be in various forms.

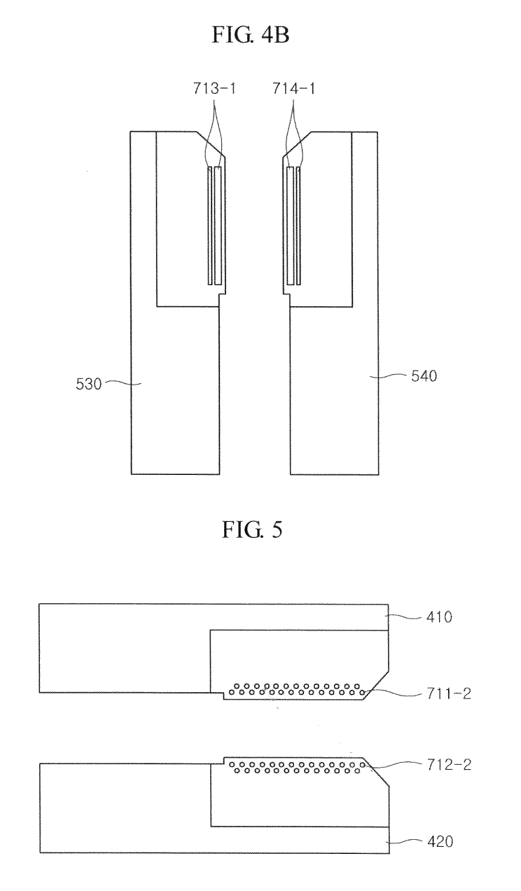

FIGS. 4A, 4B and 5 are plan views of a slit unit according to an exemplary modifications of the first embodiment of the present invention. These embodiments are similar to the first embodiment except for the configuration of the second slit section 700. For the sake of convenience of illustration, only the first laser light-blocking section 400 is shown since the second laser light-blocking section has the same configuration as the first laser light-blocking section 400.

Referring to FIGS. 4A and 4B, the first slit 711-1 is formed in the first plate 410, and the second slit 712-1 is formed in the second plate 420. The first slit 711-1 includes a plurality of rectangular holes (two holes in the present embodiment) that are spaced apart from one another. The second slit 712-1 includes a plurality of rectangular holes (two holes in the present embodiment), which are spaced apart form one another. Although the rectangular holes have the same size, they are not limited thereto. As shown in FIG. 4B, the rectangular holes may have different sizes.

Referring to FIG. 5, the first slit 711-2 is formed in the first plate 410, and the second slit 712-2 is formed in the second plate 420. Each of the slits 711-2 and 712-2 includes a plurality of holes spaced apart from one another.

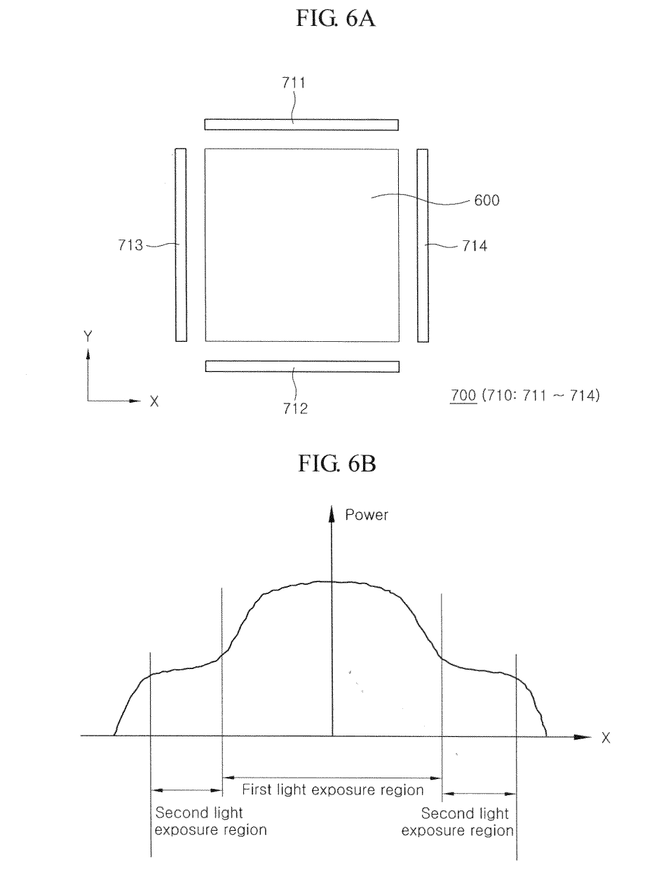

FIG. 6A is a schematic plan view illustrating a light exposure region of the slit unit shown in FIG. 2, and FIG. 6B is a diagram illustrating a power distribution of laser light transmitted through the slit unit.

Referring to FIGS. 6A and 6B, the light exposure region is defined by the first slit section 600 and the second slit section 700 of the slit unit 300. The second slit section 700 is disposed being spaced apart from the first slit section 600. The light exposure region includes a first light exposure region defined by the first slit section 600, and a second light exposure region defined by the second slit section 700.

Laser light incident on the slit sections is fully transmitted through the first slit section 600 to define a full light exposure region (i.e., the first light exposure region), and the laser light diffracts and interferes at edges of the slits in the second slit section 700 to define a partial light exposure region (i.e., the second light exposure region) (See FIG. 6B). As a result, laser light transmitted through the slit unit 300 has high power at its central portion and gradually reduced power at its peripheral portion.

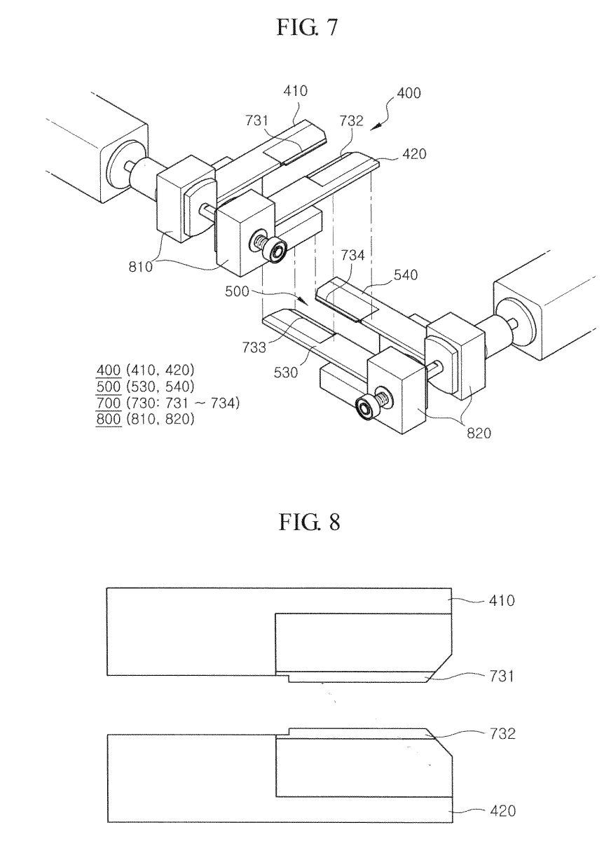

FIGS. 7 and 8 are a perspective view and a plan view illustrating a slit unit according to a second embodiment of the present invention, respectively. The slit unit according to the second embodiment of the present invention is similar to the first embodiment except the configuration of the second slit section 700.

Referring to FIGS. 7 and 8, the slit unit 300 includes a first laser light-blocking section 400, a second laser light-blocking section 500, a first slit section 600, a second slit section 700, and a driving section 800. The driving section 800 includes a first driving section 810 and a second driving section 820.

The first slit section 600 is formed by disposing the first laser light-blocking section 400 and the second laser light-blocking section 500 to intersect each other.

The first laser light-blocking section 400 includes a first plate 410 and a second plate 420 spaced apart from the first plate 410, and the second laser light-blocking section 500 includes a third plate 530 and a fourth plate 540 spaced apart from the third plate 530.

The second slit section 700 includes a semi-transmissive portion 730 made of a semi-transmissive material capable of transmitting a part of laser light incident thereon. In this embodiment, the semi-transmissive portion 730 of the second slit section 700 includes a first semi-transmissive plate 731 formed at one end of the first plate 410, a second semi-transmissive plate 732 formed at one end of the second plate 420, a third semi-transmissive plate 733 formed at one end of the third plate 530, and a fourth semi-transmissive plate 734 formed at one end of the fourth plate 540. The semi-transmissive portion 730 is formed of a material capable of transmitting only a part of the laser light, e.g., semi-transmissive glass or semi-transmissive metal. Alternatively, the semi-transmission portion 730 may be formed of the same material as the first laser light-blocking section 400 and the second laser light-blocking section 500, e.g., a metallic material. In this case, the semi-transmissive portion 730 is formed to have a very small thickness such that it can transmit a part of the laser light therethrough.

Although all the first to fourth plates 410, 420, 530 and 540 are formed with semi-transmissive portions 731, 732, 733 and 734 on their associated plates in this embodiment, this is only for illustrative purposes. Only some of the plates (e.g., one to three plates) may be formed with semi-transmissive portions, if necessary.

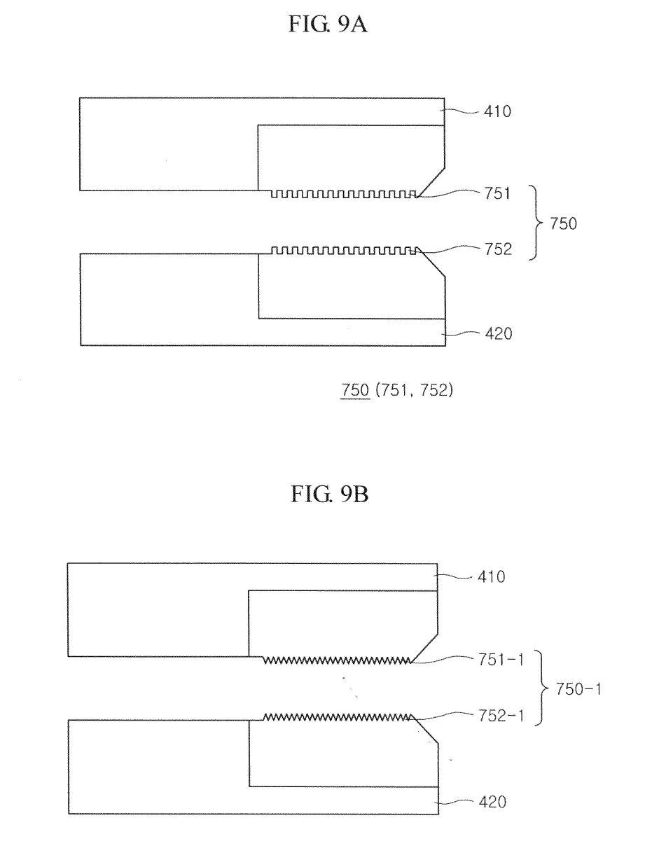

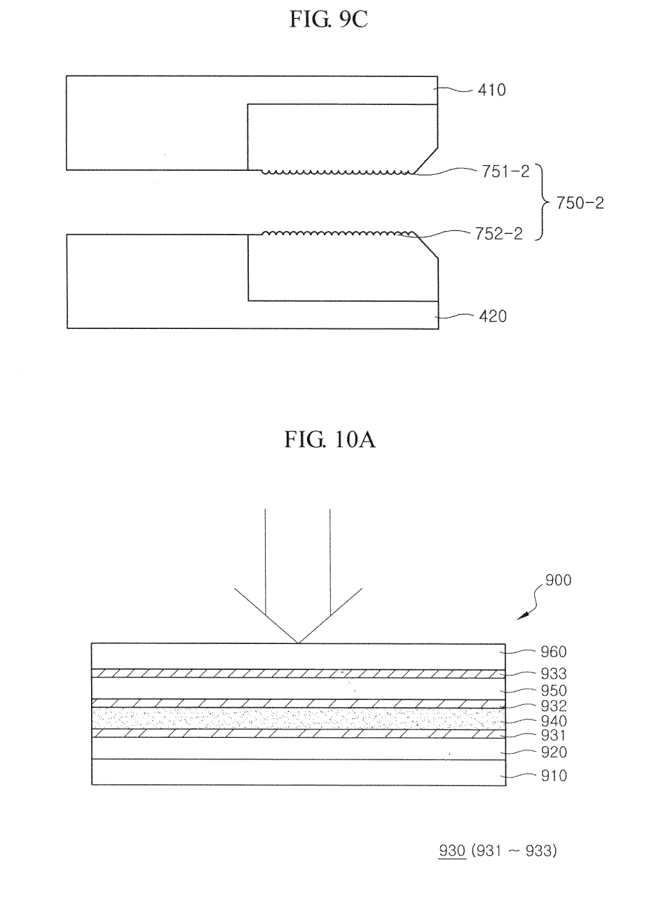

FIGS. 9A to 9C are schematic plan views of a slit unit according to a third embodiment of the present invention. The slit unit according to the third embodiment of the present invention is similar to the aforementioned embodiments except the configuration of the second slit section 700. For the sake of convenience of illustration, only the first laser light-blocking section 400 is shown and the second laser light-blocking section having the same configuration as the first laser light-blocking section 400 is not shown.

Referring to FIGS. 9A to 9C, the first laser light-blocking section 400 includes a first plate 410 and a second plate 420 spaced apart from the first plate 410, and the second laser light-blocking section (not shown) includes a third plate (not shown) and a fourth plate (not shown) spaced apart from the third plate.

The second slit section 700 includes uneven edges 750 capable of transmitting a part of laser light incident thereon. In this embodiment, the uneven edges 750 of the second slit section 700 includes a first uneven edge 751 formed at one end of the first plate 410, a second uneven edge 752 formed at one end of the second plate 420, a third uneven edge (not shown) formed at one end of the third plate (not shown), and a fourth uneven edge (not shown) formed at one end of the fourth plate (not shown).

In the embodiment shown in FIG. 9A, the uneven edges 750 are formed in a square or rectangular shape. In the embodiment shown in FIG. 9B, slit section 750-1 includes sawtooth shaped slots 751-1 and 752-1. In the embodiment shown in FIG. 9C, slit section 750-2 includes rounded projections 751-2 and 752-2. The uneven edges may be formed in various other shapes.

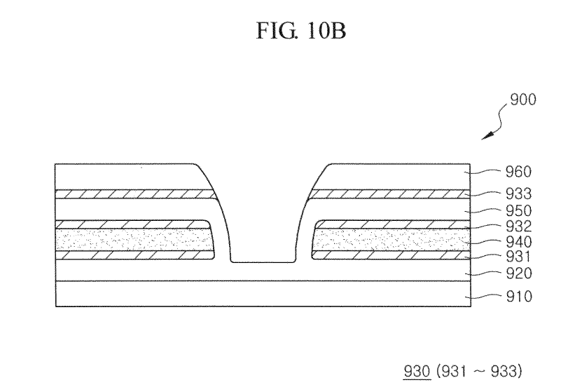

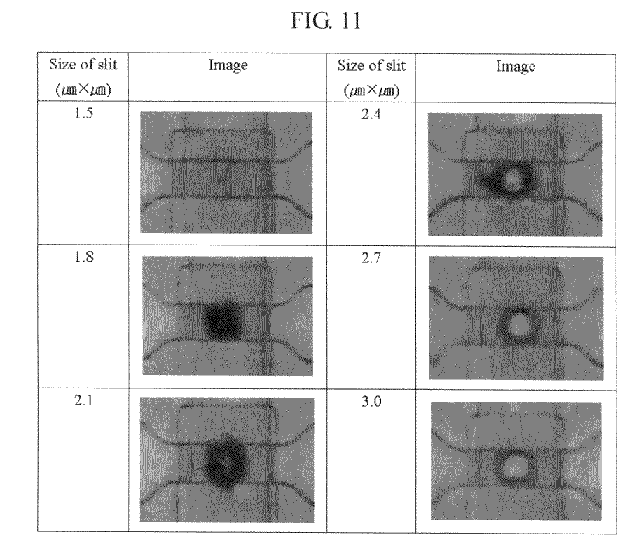

FIGS. 10A and 10B are cross-sectional views of a portion of a liquid crystal display panel that is subjected to a repair process using a laser repair system according to an embodiment of the present invention.

Referring to FIGS. 10A and 10B, a flat display panel 900 to be subjected to a repair process using the laser repair system according to the present invention includes a substrate 910, a first conductive layer 920, a first capping layer 931, an insulating layer 940, a second capping layer 932, a second conductive layer 950, a third capping layer 933, and a passivation layer 960, which are sequentially laminated. If the first conductive layer 920 and the second conductive layer 950 are formed using low-resistance wiring such as pure aluminum, capping layers 930 are formed on and beneath the conductive layers to improve contact resistance. The use of the capping layers 930 leads to reduced thicknesses of the first and second conductive layers 920 and 950. Accordingly, a repair margin is decreased.

By using the laser repair system having the slit unit according to the embodiment of the present invention, laser light transmitted through the slit unit has high power at its central portion and gradually reduced power at its peripheral portion (see FIG. 6B).

When a welding process is performed by irradiating the laser light having such a power distribution onto a region to be repaired, a portion of the laser light with high power is irradiated on a central area of the region to be repaired so that residues are removed therefrom, and another portion of the laser light with relatively low power is irradiated on peripheral areas of the region to be repaired where electrical connections are actually made, resulting in improvement of the margin of laser power. In other words, the central portion of the laser light with the high power functions to remove the passivation layer 960 and the insulating layer 940, and the peripheral portion of the laser light with the relatively low power functions to partially melt the first conductive layer 920 and the second conductive layer 950 to electrically connect the conductive layers to each other.

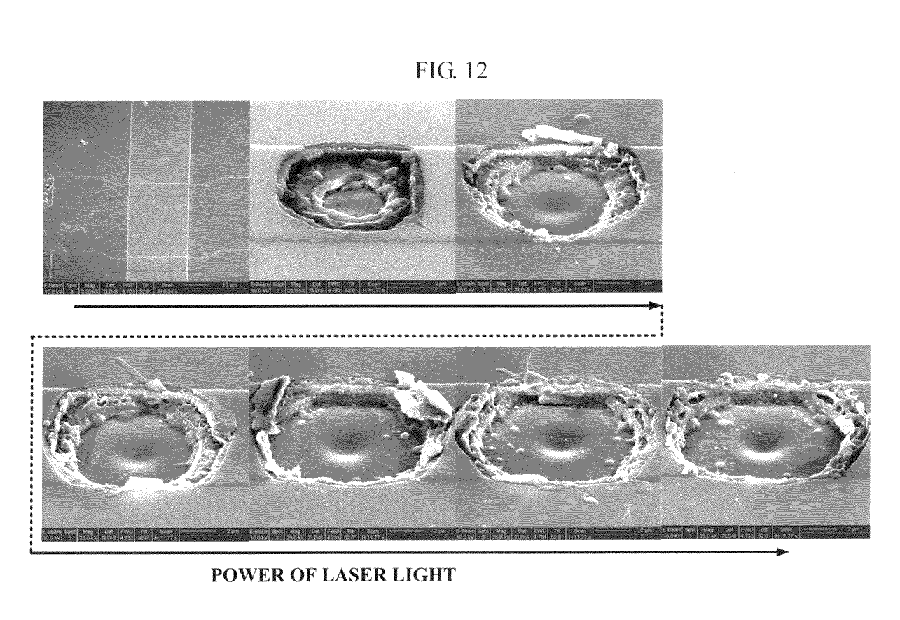

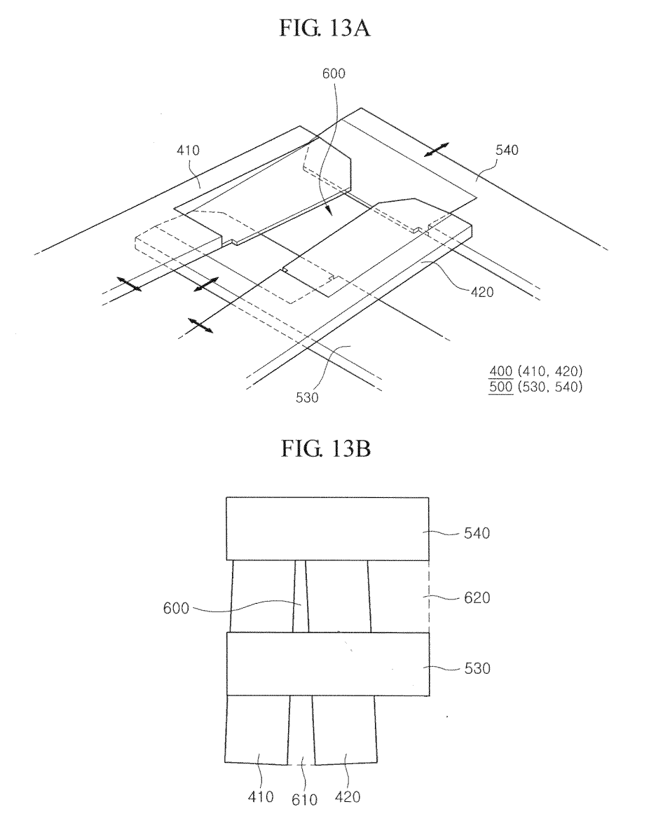

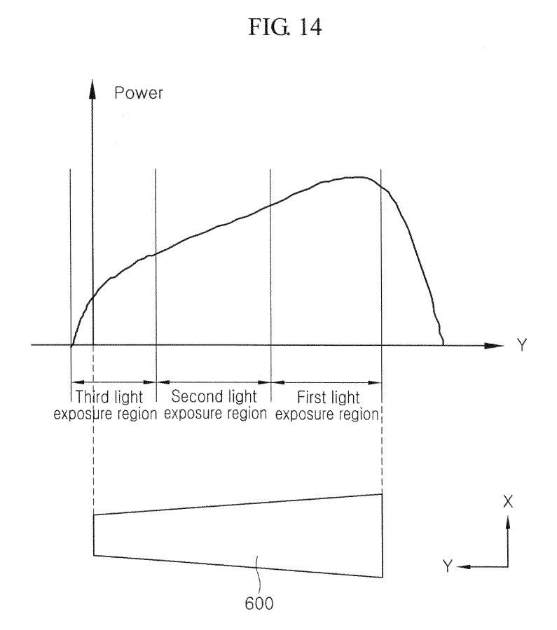

FIG. 11 illustrates images showing laser repair results depending on the size of a slit with a constant power of laser light. FIG. 12 illustrates images showing laser repair results depending on the power of laser light with a constant slit size. FIGS. 13A and 13B are perspective view and a plan view of a slit unit according to a fourth embodiment of the present invention, respectively. FIG. 14 is a diagram illustrating a power distribution of laser light transmitted through the slit unit according to the fourth embodiment of the present invention.

Referring to FIGS. 11 and 12, it can be seen that the processed configuration of a region on which the laser light is irradiated depending on changes in the size of the slit (see FIG. 11) tends to be similar to that of a region on which the laser light is irradiated depending on changes in the power of laser light (see FIG. 12).

In other words, effects obtained when the power of the laser light is fixed and the size of the slit is increased are identical with those obtained when the size of the slit is fixed and the power of the laser light is increased. Accordingly, by changing the size of the slit based on such a phenomenon, it is possible to obtain effects resulting from changes in the power of the laser light.

The above results may be applied to the laser repair system. As described in the embodiments, laser light with various power distributions can be made by simply changing the size of a slit depending on positions, for which only a single slit is used. This will be described in greater detail in connection with the following embodiment.

Referring to FIGS. 13A and 13B, a slit unit 300 includes a first laser light-blocking section 400, a second laser light-blocking section 500, a first slit section 600, and a driving section (not shown). The driving section includes a first driving section (not shown) and a second driving section (not shown).

The first and the second laser light-blocking section 400 and 500 of the slit unit 300 block all of laser light incident thereon. The first and the second laser light-blocking section 400 and 500 are made of a laser light-blocking material. Although the first and the second laser light-blocking section 400 and 500 are made of a metallic material in this embodiment, they are not limited thereto but may be made of various materials.

The first slit section 600 is formed by the first and the second laser light-blocking section 400 and 500. The first laser light-blocking section 400 includes a first plate 410 and a second plate 420. The first plate 410 has one end connected to the first driving section (not shown), and the second plate 420 has one end connected to the first driving section (not shown). Further, the first plate 410 and the second plate 420 are disposed being spaced apart from each other and inclined with respect to each other in an identical plane, thereby defining a first opening 610. As a result, the first opening 610 is formed such that the width thereof is gradually decreased from one end to the other end.

The second laser light-blocking section 500 is disposed to intersect the first laser light-blocking section 400 and includes a third plate 530 and a fourth plate 540. The third plate 530 has one end connected to the second driving section 820 and the fourth plate 540 has one end connected to the second driving section 820. The third plate 530 and the fourth plate 540 are spaced apart from each other to define a second opening 620. As a result, the second opening 620 is formed in a rectangular or square shape.

The first slit section 600 is formed by an overlapping area of the first opening 610 defined by the first laser light-blocking section 400 and the second opening 620 defined by the second laser light-blocking section 500 (see FIG. 13B). As a result, the first slit section 600 is formed in a trapezoidal shape having a gradually reduced width from one end to the other end.

Although the third plate 530 and the fourth plate 540 are disposed in parallel with each other in an identical plane in this embodiment, they are not limited thereto but may be inclined with respect to each other in an identical plane.

Meanwhile, although the slit unit according to this embodiment has only the first slit section, the slit unit is not limited thereto but may have a second slit section as described above, if necessary.

The power distribution of the laser light transmitted through the slit unit according to this embodiment is described with reference to FIG. 14. It can be seen that the power of the laser light becomes higher as the size of the opening of the first slit section 600 increases. Accordingly, a light exposure region corresponding to the first slit section 600 includes a first light exposure region in which the power of the laser light is relatively high, a third light exposure region in which the power is relatively low, and a second light exposure region in which the power is intermediate. As a result, the use of the laser repair system with the slit unit according to the embodiment of the present invention enables the laser light transmitted through the slit unit to have a power distribution in which power is high at one end and then gradually reduced toward the other end.

When the laser light having such a power distribution is irradiated on a region to be repaired in a welding process, one end of the laser light having high power is used to remove residues and the other end of the laser light having relatively low power is used to make an electrical connection, thereby improving the margin of a laser repair process.

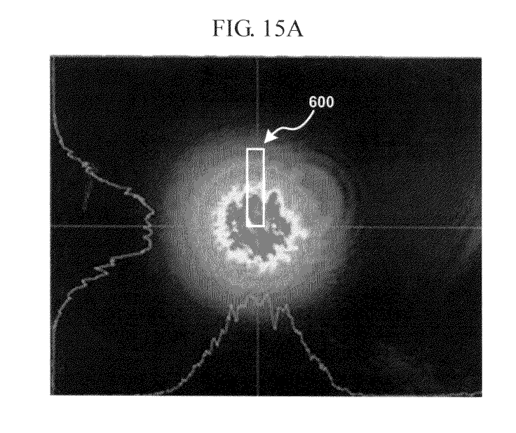

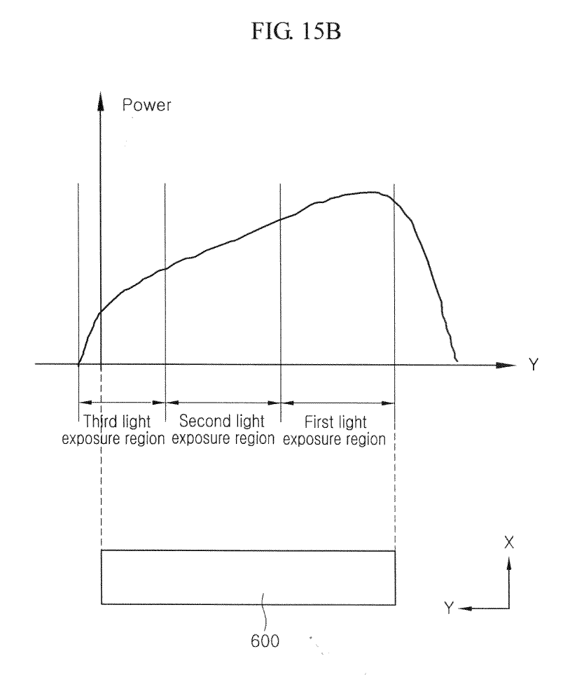

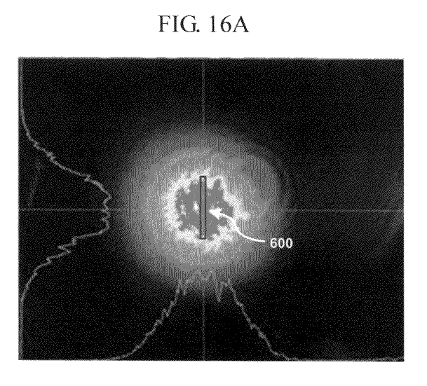

FIG. 15A is a schematic view of a slit unit according to a fifth embodiment of the present invention, and FIG. 15B is a diagram illustrating a power distribution of laser light transmitted through the slit unit according to the fifth embodiment of the present invention.

Referring to FIGS. 15A and 15B, a slit unit 300 includes a first laser light-blocking section (not shown), a second laser light-blocking section (not shown), a first slit section 600, and a driving section (not shown).

The first slit section 600 of the slit unit 300 is formed by a first laser light-blocking section and a second laser light-blocking section. In this embodiment, the first slit section 600 is formed in a rectangular shape and located and aligned in front of a light oscillator (not shown) such that a central portion of the laser light is transmitted through one end of the first slit section 600 and a peripheral portion of the laser light is transmitted through the other end of the first slit section. That is, the center of the first slit section 600 is disposed at the peripheral portion of the laser light rather than at the central portion of the laser light, so that the laser light having a various power distribution can be transmitted through the first slit section 600.

As a result, upon use of the laser repair system according to the embodiment of the present invention, the laser light transmitted through the first slit section 600 of the slit unit has a power distribution in which power is high at one end and then gradually reduced toward the other end (see FIG. 15B).

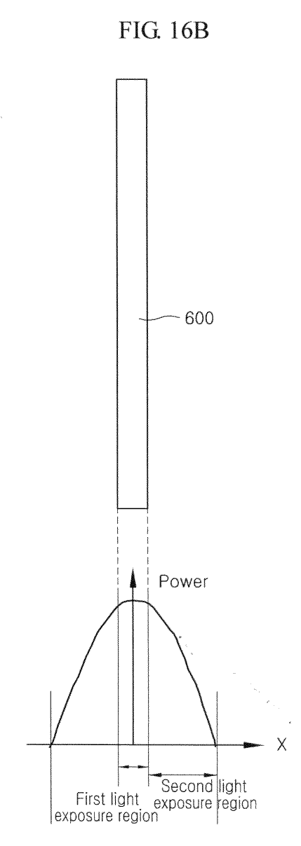

FIG. 16A is a schematic plan view of a slit unit according to a sixth embodiment of the present invention, and FIG. 16B is a diagram illustrating a power distribution of laser light transmitted through the slit unit according to the sixth embodiment of the present invention.

Referring to FIGS. 16A and 16B, the first slit section 600 of the slit unit according to this embodiment is formed as a rectangular slit having a length ratio of a first side (i.e., x-axis side) to a second side (i.e., y-axis side) of 1:100˜1:1000. As the length of the first side of the rectangular slit is extremely reduced and laser light having relatively high power is then irradiated on and transmitted through the slit unit, it is possible to obtain laser light having a concentrated power distribution as shown in FIG. 16B. The length ratio of the first side to the second side of the rectangular slit in the present embodiment is only for illustrative purposes and may be variously changed.

As described above, according to the present invention, a power distribution of laser light can be variously adjusted according to conditions of a laser repair process.

Furthermore, a power distribution of laser light suitable for conditions of a laser repair process can be easily adjusted using the slit unit, thereby ensuring the margin of the laser repair process and minimizing process time and a failure probability.

The foregoing is merely the illustrative embodiments of the laser repair system according to the present invention. The present invention is not limited to the embodiments described above but defined by the appended claims. Accordingly, it will be understood by those skilled in the art that various modifications and changes can be made thereto without departing from the spirit and scope of the invention defined by the appended claims.

What is claimed is:

1. A laser repair system comprising:
a laser light oscillator for generating laser light; and
a slit unit on which the laser light is irradiated, the slit unit comprising a first laser light-blocking section and a second laser light-blocking section which collectively define a laser light passage region.

2. The system according to claim 1, wherein the first laser light-blocking section comprises first and second light-blocking members having first and second edges which define first and second sides of the laser light passage region respectively, and the second light laser light-blocking section comprises third and fourth light-blocking members having third and fourth edges which define third and fourth sides of the laser light passage region respectively.

3. The system according to claim 2, wherein at least one of the light-blocking members comprises at least one aperture adjacent to the edge of the light-blocking member which defines a side of the light passage region.

4. The system according to claim 2, wherein a plurality of the laser light-blocking members comprise an aperture adjacent to their respective edges which define sides of the first laser light passage region.

5. The system according to claim 2, wherein the edge of at least one of the laser light-blocking members includes a curved pattern.

6. The system according to claim 5, wherein the curved pattern is selected from the group comprising rectangular-shaped, sawtooth-shaped and rounded shape.

7. The system according to claim 3, wherein the at least one aperture comprises a plurality of apertures.

8. The system according to claim 7, wherein the plurality of apertures are rectangular or circular.

9. The system according to claim 8, wherein one of the rectangular apertures has an area which is different from an area of another of the rectangular apertures.

10. The system according to claim 2, wherein an edge of at least one of light-blocking members comprises a semi-transmissive portion which allows partial passage of an amount of laser light irradiated on the semi-transmissive portion.

11. The system according to claim 10, wherein the semi-transmissive portion is comprised of semi-transmissive glass, or a metal having a thickness sufficient to provide a semi-transmissive characteristic.

12. The system according to claim 2, wherein the slit unit further comprises a driving section for changing positions of the first laser light-blocking section and the second laser light-blocking section.

13. The system according to claim 12, wherein the driving section comprises:
a first driving section connected to the first laser light-blocking section to move the first and the second light-blocking members along a first direction; and
a second driving section connected to the second laser light-blocking section to move the third and the fourth light-blocking members along a second axis direction.

14. A laser repair system comprising:
a laser light oscillator for generating laser light; and
a slit unit on which the laser light is irradiated, the slit unit comprising a laser light-blocking section and a first slit section,
wherein the laser light-blocking section of the slit unit does not transmit laser light incident thereon, and
the first slit section transmits laser light incident thereon and filters the laser light such that the transmitted laser power has a desired distribution.

15. The system according to claim 14, wherein the first slit section is formed in a polygonal shape so that the width of one side is different from that of the opposite side.

16. The system according to claim 14, wherein the laser light-blocking section comprises:
a first laser light-blocking section defining a first opening, and
a second laser light-blocking section defining a second opening, and
wherein the first and the second laser light-blocking sections are disposed to intersect each other,
the first slit section comprises an overlapping region of the first and the second openings, and
at least one of the first and the second openings has a varying width.

17. The system according to claim 16, wherein the first laser light-blocking section comprises a first plate and a second plate spaced apart from the first plate,
the second laser light-blocking section comprises a third plate and a fourth plate spaced apart from the third plate, and
the first and the second plate are disposed to be inclined with respect to each other in an identical plane.

18. The system according to claim 17, wherein the third and the fourth plate are disposed to be inclined with respect to each other in an identical plane.

19. The system according to claim 17, wherein the slit unit further comprises a second slit section,
the second slit section is formed in the laser light-blocking section, and
the amount of light transmitted through the second slit section is less than that of light transmitted through the first slit section.

20. The system according to claim 18, wherein the slit unit further comprises a driving section for changing positions of the first and the second laser light-blocking sections.

21. The system according to claim 14, wherein a central portion of the first slit section is positioned in a peripheral region of the laser light.

22. The system as claimed in claim 21, wherein the first slit section comprises a rectangular slit whose length ratio of a first to a second side is 1:100˜1:1000.
